(19) United States
(12) Patent Application Publication
(10) Pub. No.: US 2018/0310363 A1
(43) Pub. Date: Oct. 25, 2018

(54) COLOR-CHANGING HEAT MATS

(71) Applicants: Robert Varnedoe, Homerville, GA (US); Jonathan Landrum, Homerville, GA (US); Joel Varnedoe, Homerville, GA (US); Jim Strickland, Dupont, GA (US); Doug Tomlinson, Homerville, GA (US)

(72) Inventors: Robert Varnedoe, Homerville, GA (US); Jonathan Landrum, Homerville, GA (US); Joel Varnedoe, Homerville, GA (US); Jim Strickland, Dupont, GA (US); Doug Tomlinson, Homerville, GA (US)

(21) Appl. No.: 15/958,764

(22) Filed: Apr. 20, 2018

Related U.S. Application Data
(60) Provisional application No. 62/488,193, filed on Apr. 21, 2017.

(51) Int. Cl. H05B 3/36; B32B 27/06; B32B 27/20; B32B 27/32

(52) U.S. Cl. CPC H05B 3/36; B32B 27/06; B32B 27/20; B32B 2471/04; B32B 2307/4026; B32B 2323/043; B32B 27/32

(57) ABSTRACT

Embedded thermochromic pigments address problems associated with determining whether an electrically heated mat is operating properly. At least a portion of the mat, or an attachment, includes a thermochromic pigment, such that when the mat is properly activated, the entire mat, or a region of the mat, changes color, hue or intensity, giving a visual indication as to heating status. The thermochromic pigment may change the color at a predetermined temperature associated with animal husbandry such as 80 Deg. F in conjunction with a farrowing application. One or both of the upper and lower layers of the mat may be constructed of plastic such as high-density polyethylene (HDPE), and the thermochromic pigment may be added to the plastic prior to molding the mat. Alternatively, the thermochromic pigment may be contained in a label or patch affixed to the mat material through a mold labeling process.

### REFERENCE TO RELATED APPLICATIONS

This application claims priority to, and claims the benefit of, U.S. Provisional Patent Application Ser. No. 62/488,193, filed Apr. 21, 2017, the entire content of which is incorporated herein by reference.

### FIELD OF THE INVENTION

This invention relates generally to floor mats and, in particular, to a mat with an indicator that changes color when heated.

### BACKGROUND OF THE INVENTION

Farrowing refers to birthing a litter of pigs. This process has been well studied and optimum conditions are known with precision. Piglets must be kept from becoming chilled, which can result in fewer healthy, thriving piglets. The environment should include a draft-free zone of warm air. On the floor, in the piglet zone, a constant. temperature of 80-90 degrees F. (27-32 degrees C.) is desirable during farrowing, or until animals are older and have less need for supplemental heat.

Supplemental heat may be provided from the top down or the bottom up. Radiant heat may be provided from above, as through heat lamps. Top-down heat provides a zone of comfort for animals to go to the feeder, get a drink and then lie down again under the heat source. However, since heat rises, a heat source under the piglets is more practical and economical. Heat is not lost because the heat source is completely utilized by the litter.

For pigs up to 21 days of age, heating pads are the preferred choice for many reasons. First, a farrowing stall is rectangular, and the pig heat mat fits logically in the creep area. Second, by utilizing pig heating pads, there is no chance of “blowing a bulb,” which happens often with heat lamps. If a blown bulb is not discovered on a timely basis, animals could be without heat, causing health problems. Pig heating pads also provide a solid surface, whereas a heat lamp requires a rubber mat under it.

While heating mats may use hot water, in the U.S., electric heat pads are primarily used because most producers have perforated floors without any concrete. Many installations use controllers to set the desired temperature. In this way, heat can effectively be ramped down as animals grow, thus reducing energy usage and cost.

While electrically operated farrowing mats are convenient and effective, one problem is confirming that they are ON and operating properly. When using heating lamps, one can verify if they are ON or OFF simply by looking at them. When using existing heating mats, however, they must be touched to confirm appropriate warmth generation. Since many barns are very large with numerous mats, ON/OFF confirmation can be a tedious process.

### SUMMARY OF THE INVENTION

This invention solves problems associated with determining whether an electrically heated mat is operating properly through the use of thermochromic pigments. More specifically, at least a portion of the material comprising the mat includes a thermochromic pigment causing that portion to change color in response to heating of the elements. Accordingly, when the mat is properly activated, the entire mat, or a region of the mat, changes color, hue or intensity, giving a visual indication of heating status.

The peripheral shape of the mat may be rectangular, square, oval or circular, and the thermochromic pigment may change the color at a predetermined temperature associated with animal husbandry such as 80 Deg. F in conjunction with a farrowing application.

One or both of the upper and lower layers of the mat may be constructed of plastic such as high-density polyethylene (HDPE), and the thermochromic pigment may be added to the plastic prior to molding the mat. Alternatively, the thermochromic pigment may be contained in a specific localized region of the upper layer of material such as a label or patch affixed to the mat material through a mold labeling process. Such a label may be virtually any shape or size so long as it is viewable at a reasonable distance from the mat.

### BRIEF DESCRIPTION OF THE DRAWINGS

FIG. 1A shows an unheated mat containing a thermochromic pigment;

FIG. 1B shows the mat of FIG. 1A in a heated state;

FIG. 2A shows an unheated mat with a label or patch containing a thermochromic pigment; and

FIG. 2B shows the mat of FIG. 2A in a heated condition.

### DETAILED DESCRIPTION OF THE INVENTION

This invention solves problems associated with determining heating mat ON/OFF conditions through the use of a thermo-chromic pigment added to the construction of the mat itself. In broad and general terms, this additive causes the mat to change color when heated, affording a straightforward visual confirmation.

The preferred embodiments use a thermochromic pigment in the plastic itself to make the heat mat change color depending on its temperature. This change of color provides a reliable and highly visible indication of the proper functioning of the electric heat mat.

The mats may be made of various plastic materials though high-density polyethylene (HDPE) is preferred for reasons of strength and cost. In accordance with the invention the thermochromic pigment(s) is/are added to the HDPE recipe. When the mat reaches a given trigger temperature, the color of the heat mat changes as the pigments are activated, altering visual appearance.

There are several commercial sources of thermochromic pigments. One such source of is PolyOne Corp. of Avon Lake, Ohio. Thermochromic pigments are generally colored below a set transition point and then change to a colorless state above a predetermined point. This effect can also be used to create a color shift between two colors as one of the components disappears, leaving a secondary color (for instance a green starting color transitioning to yellow once the thermochromic blue disappears). There are a wide range of primary transition colors available, as well as a variety of color shifts. Examples include orange or green to yellow (when heated); blue to green; violet to blue or magenta; brown or black to tan or red; and so forth. According to PolyOne, available transition temperatures range from −10° C. to 72° C., typically +/−5° C.

In one example according to this invention, the thermochromic pigment changes the color of the heat mat from purple to pink or magenta at a temperature of approximately 80 Deg. F. While this is well-suited to the fallowing industry, the invention is not limited in this regard as different colors and transition temperatures may be used for different applications and industries, including different animals, including pets.

Other attributes of the inventive mats are as follows:
In some embodiments, the mat will produce a temperature equal to 37 degrees Fahrenheit above ambient temperature. Through the use of appropriate controllers, the 37 degree differential can be reduced to meet the individual needs of the customer.
The mats are available in two electrical configurations (110-120 Volts and 220-240 Volts).
The mats are designed for hog farrowing crates, free stall & nursery pens.
The mats create a heated surface with even heat at all points.
The mats have insulated bottom to prevent downward heat loss.
The mats are traction designed, non-slip surface.
Double mats used in larger crates have a recess for pen dividers.

While the color-changing heat mats are ideally suited to farrowing applications, the invention is not limited in terms of the targeted animals/pets or the stages of growth. Nor is the invention limited to particular environments (i.e., farrowing crates, homes, farm, etc.); formats (i.e., rectangular, oval, square, circular, enclosures, cylinders, etc.); temperature ranges, set points, or the colors involved as the technology allows.

The mats may be produced in the following dimensions and formats (single and double widths provided by Kane Manufacturing Co., Inc. of Pleasant Hill, Iowa):
PHMS 18 18″×18″(45.72×45.72 cm)—mainly used for pets
PHMS 28 18″×28″ (45.72×71.72 cm)—mainly used for pets
PHMS 36 13.5″×36″ (30×91 cm)
PHMS 48 13.5″×48″ (30×122 cm)
PHMS 60 13.5″×60″ (30×152 cm)
PHMS 45 18.25″×45″(46.35×114.3 cm)
PHMS 57 18.25″×57″(46.35×144.78 cm)
PHMD 36 27″×36″(68.58×91.44 cm) Double Mat
PHMD 48 27″×48″(68.58×121 cm) Double Mat
PHMD 60 27″×60″ (68.58×152.4 cm) Double Mat

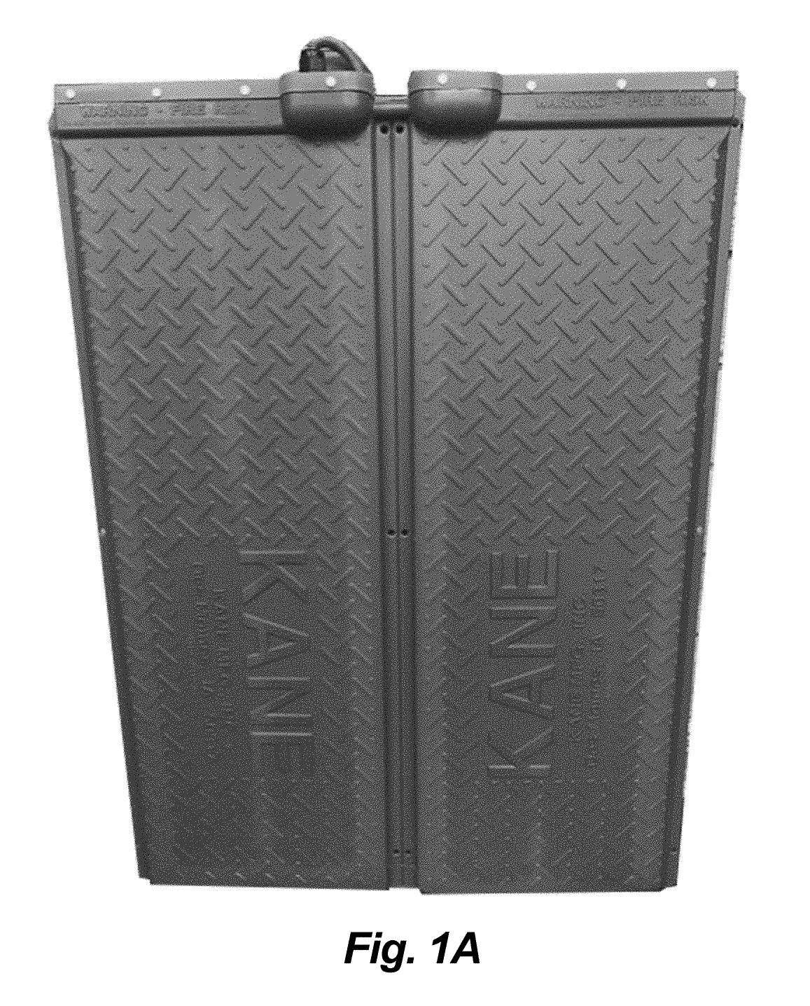

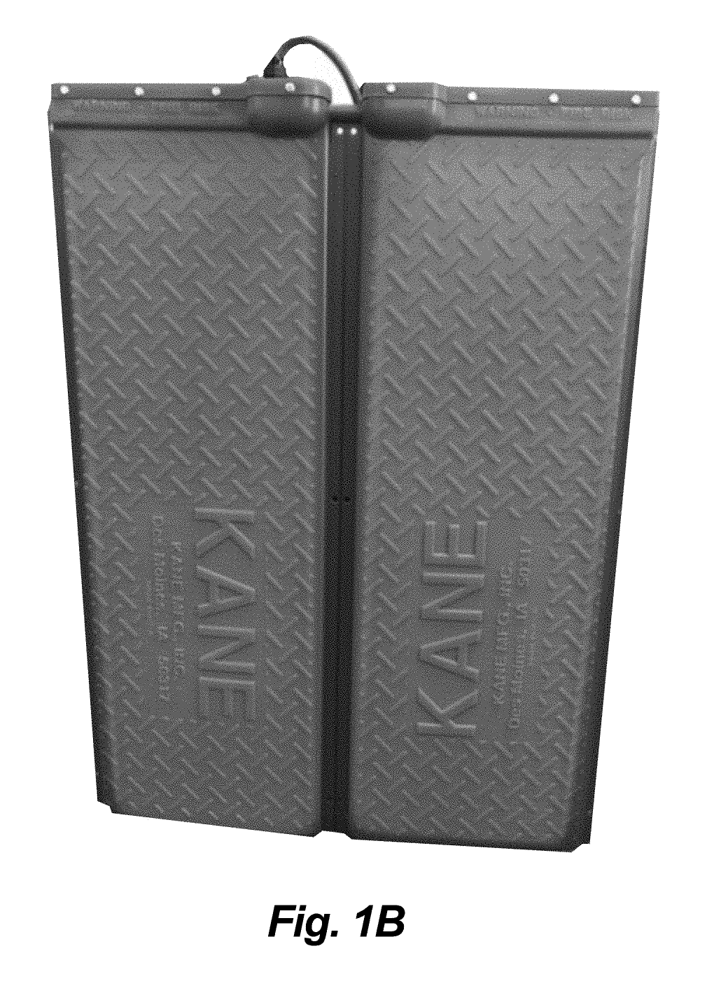

The attached figures show a color-changing PHMD 36 double mat measuring 27″×36″. This mat is constructed with upper and lower layers of HDPE housing separate heating elements in each section. In accordance with the instant invention, at least a portion of at least the upper layer of material includes a thermochromic pigment causing that portion to change color in response to heating of the elements. FIG. 1A shows a darker mat in an unheated state, whereas FIG. 1B shows a lighter mat in a heated condition.

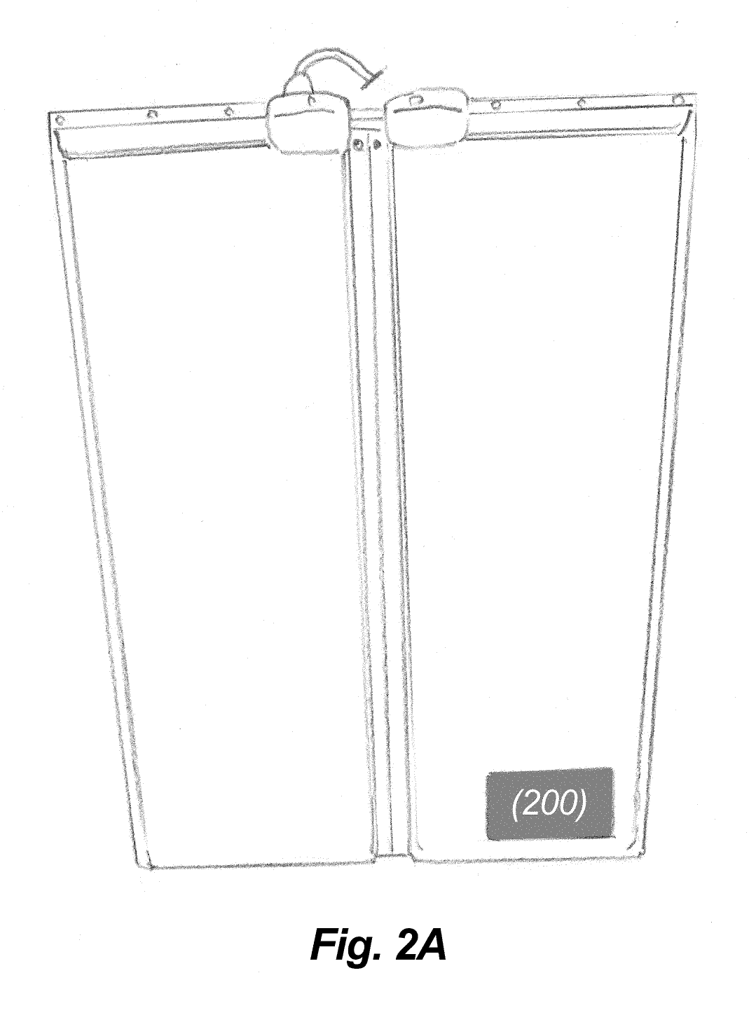

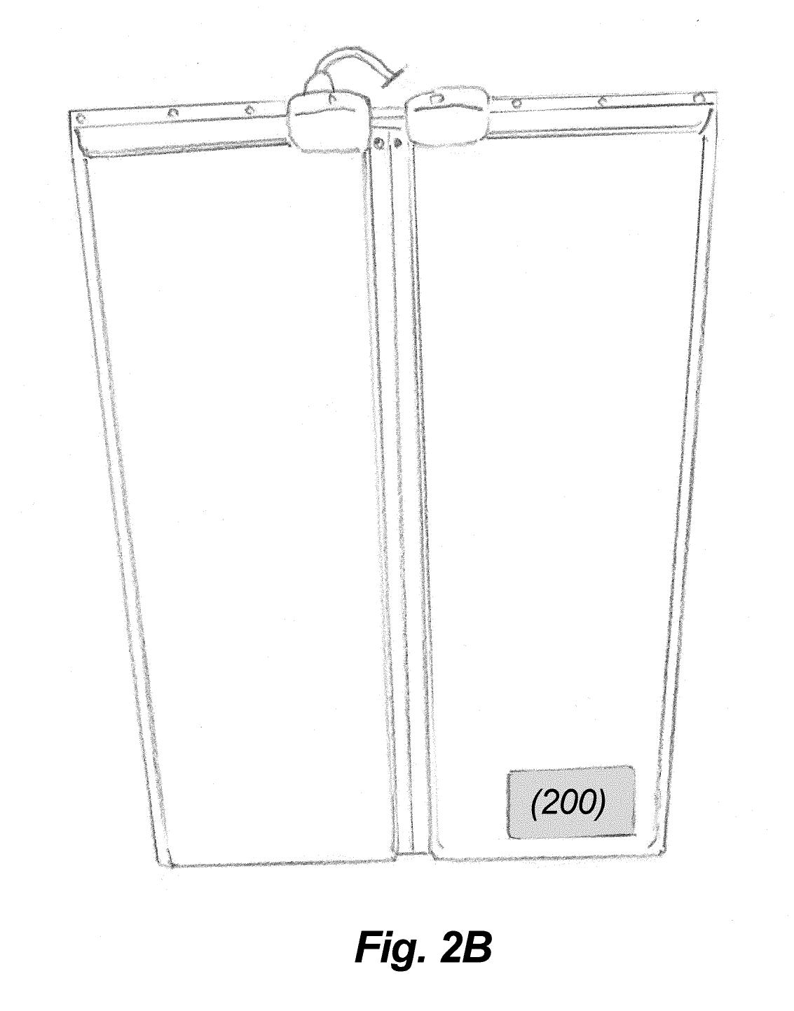

As opposed to incorporating a thermochromic pigment into the entire article, a smaller portion, patch or label may be used. FIG. 2A shows a label 200 on a mat in an unheated state, whereas FIG. 2B shows the label in a heated condition. The label will have a specific area that will change color(s) in the same format as the entire heat changing mat. Note that the label has changed from a darker tone to a lighter one in FIGS. 2A to 2B. In this embodiment the label may be made of a polymeric composition and affixed by a process called “in mold labeling.” Mold labeling is the process of placing a label in the mold prior to the part being molded, such that the label is permanent. The size and/or placement of the label is variable, with the goal being that the label is visible from a reasonable distance such as 12 feet. Accordingly, for farrowing mat applications, the label will may be on the order of 11.5×6.5″ more or less.

In alternative embodiments, the color-changing heat mats may be provided in color pairs, which correspond to different temperature trigger points. For the raising of piglets, the purple/pink color pair matches the needs of the applications; for other applications different color pairs will satisfy the customer's needs.

1. A color-changing heat mat, comprising:
upper and lower layers of material defining a peripheral shape;
electrical heating elements disposed between the upper and lower layers;
a power cord adapted to connect the electrical heating elements to a source of electrical power; and
wherein at least a portion of the upper layer of material includes a thermochromic pigment causing that portion to change color in response to heating of the elements.

2. The color-changing heat mat of claim 1, wherein the peripheral shape is rectangular, square, oval or circular.

3. The color-changing heat mat of claim 1, wherein the thermochromic pigment changes the color of the heat mat at a predetermined temperature associated with animal husbandry.

4. The color-changing heat mat of claim 1, wherein the thermochromic pigment changes the color of the heat mat at a temperature of approximately 80 Deg. F in conjunction with a farrowing application.

5. The color-changing heat mat of claim 1, wherein the thermochromic pigment changes the color of the heat mat from purple or violet to pink or magenta at a temperature of approximately 80 Deg. F in conjunction with a farrowing application.

6. The color-changing heat mat of claim 1, wherein one or both of the upper and lower layers of material are made of plastic.

7. The color-changing heat mat of claim 4, wherein the thermochromic pigment is added to the plastic prior to molding the mat.

8. The color-changing heat mat of claim 1, wherein one or both of the upper and lower layers of material are made of high-density polyethylene (HDPE).

9. The color-changing heat mat of claim 6, wherein the thermochromic pigment is added to the HDPE prior to molding the mat.

10. The color-changing heat mat of claim 1, further including an electrical controller to adjust the temperature of the mat.

11. The color-changing heat mat of claim 1, adapted for use in a farrowing environment.

12. The color-changing heat mat of claim 1, wherein the thermochromic pigment is contained in a specific localized region of the upper layer of material.

13. The color-changing heat mat of claim 1, wherein the thermochromic pigment is contained in a label or patch disposed in a specific region of the upper layer of material.

14. The color-changing heat mat of claim 13, wherein the label or patch is affixed to the upper layer of material through a mold labeling process.

15. The color-changing heat mat of claim 13, wherein the label or patch has an area in the range of 16 to 144 square inches.

16. The color-changing heat mat of claim 13, wherein the label or patch has an area in the range of 50 to 100 square inches.
